(19) United States
(12) Patent Application Publication
(10) Pub. No.: US 2006/0279149 A1
(43) Pub. Date: Dec. 14, 2006

(54) Passive dynamically stabilizing magnetic bearing and drive unit

(75) Inventor: Hans K. Asper, Meilen (CH)

Correspondence Address: Donald S Dowden;Cooper & Dunham, 1185 Avenue of the Americas, New York, NY, 10036, US

(73) Assignee: Silphenix GmbH, Oberdorf (CH)

(21) Appl. No.: 10/514,612

(22) PCT Filed: Apr. 11, 2003
(86) PCT No.: PCT/IB03/01451

§ 371 Date: Jun. 16, 2005

(30) Foreign Application Priority Data
May 16, 2002 (CH) 826/02

(51) Int. Cl. H02K 7/09

(52) U.S. Cl. 310/90.5

(57) ABSTRACT

The passive axial magnet bearing comprises permanent magnets (1, 2) arranged with alternating polarization on a rotor (1, 2, 8). These cause an oscillating flow through the coils (L) on both sides of the rotor (1, 2, 8). All coils (L) are series connected in an electric circuit (3). As long as the rotor (1, 2, 8) rotates in the middle position, no current flows in the electric circuit (3), since the voltages across the coils (L) cancel each other due to the symmetry. However, when the rotor (1, 2, 8) deviates from the center position, a current flows and the coils (L) exert electromagnetically a restoring force on the permanent magnets (1, 2). The bearing can also be equipped with an integrated drive. For this purpose, it is extended by drive coils. The production of the bearing is simple and inexpensive.

### CROSS REFERENCES TO RELATED APPLICATIONS

This application claims the priority of Swiss patent application 826/02, filed May 16, 2002, the disclosure of which is incorporated herein by reference in its entirety.

### TECHNICAL FIELD

Passive magnetic bearings are intended for bearing in particular very fast rotating rotors without wear and without substantial energy losses. They can in particular be used at flywheels for energy storage devices. In this, the flywheels are borne radially as well as axially without contact.

### BACKGROUND ART

Conventional mechanical bearings, as for example ball bearings, are at high speed very loud, have to be lubricated, have a large wear and are not suited for vacuum or low temperatures. Active magnetic bearings have an ongoing need for energy and are, due to the necessary position sensors, current sources and control electronics, very expensive. Passive magnetic bearings with superconductors are expensive as well and complex to produce. In addition, superconductors have to be cooled during operation. Further, they are very fragile and must therefore not be exposed to vibrations. The previously known passive magnetic bearings without superconductors, as for example the bearings described in U.S. Pat. No. 5,302,874 are also very costly to produce. Their load capacity and stiffness is imperfect. In addition the arrangement requires a high precision during production, since otherwise there are vibrations and energy losses during operation. At the arrangement of U.S. Pat. No. 5,302,874, at which there shouldn't be any flux through the coils in the equilibrium position, there is additionally the problem that the rotor expands due to the centrifugal forces and the null-flux-condition is not fulfilled any more, which leads to further energy losses. The known bearings are therefore only conditionally suited for the industrial application.

### DISCLOSURE OF THE INVENTION

Hence, there is the problem to provide a passive magnetic bearing of the kind mentioned at the outset which avoids the disadvantages mentioned above at last partially.

This problem is solved by claim 1, by the passive magnetic bearing comprising magnets and bearing coils, wherein the magnets are movable relative to the bearing coils along at least one path and the bearing coils are exposed to an oscillating magnetic flux due to the magnetic fields produced by the magnets and are connected to each other in one or several electric circuits, wherein for each electric circuit it applies that during a movement of the magnets along the path the voltages induced in the bearing coils by the oscillating magnetic flux at any point in time substantially cancel each other out and thereby no current flows and at a deviation of the magnets from the path in direction of the polarization axis of the magnets the voltages induced in the bearing coils do not cancel each other out due to the modified distances from the magnets and the thereby modified magnitude of the magnetic flux such that a current flows and the bearing coils, through which the current flows, exert a restoring force on the magnets.

As long as the rotor of the bearing rotates in the equilibrium position, there is indeed a magnetic flux through the single bearing coils, but substantially no current flows through the bearing coils. However, at the deviation from the equilibrium position current flows through the bearing coils. This characteristic is among other things achieved by the bearing coils being connected to each other in one or several electric circuits.

The bearing according to the invention has the advantage that it is easy to produce and is therewith not expensive.

### BRIEF DESCRIPTION OF THE DRAWINGS

Further embodiments, advantages and applications of the invention become apparent from the dependent claims as well as the following description which makes reference to the drawings, wherein:

FIG. 1 shows a principle diagram of the passive magnetic bearing according to the invention,

FIG. 2 shows the currents and voltages of the arrangement shown in FIG. 1,

FIG. 3 shows the arrangement of FIG. 1, however with a deviation of the magnets from the prescribed path,

FIG. 4 shows the currents and voltages of the arrangement shown in FIG. 3,

FIG. 5 shows an embodiment of the bearing according to the invention as an axial bearing with two static coil holders and one rotating magnet holder,

FIG. 6 shows an embodiment of the bearing according to the invention as an axial bearing with two rotating coil holders and one static magnet holder,

FIG. 7 shows the circuit diagram of an embodiment of the magnetic bearing according to the invention with two coil holders and eight coils connected in series,

FIG. 8 shows the circuit diagram of an embodiment of the magnetic bearing according to the invention with two coil holders and eight coils connected in pairs,

FIG. 9 shows an embodiment of the bearing according to the invention as axial bearing with three static coil holders and two rotating magnet holders,

FIG. 10 shows a preferred circuit diagram for the embodiment of the magnetic bearing according to the invention shown in FIG. 9,

FIG. 11 shows part of a coil holder of an embodiment of the magnetic bearing according to the invention,

FIG. 12 shows the part of a coil holder of FIG. 9, however, with two magnets being moved along it,

FIG. 13 shows the rotor of a magnetic bearing according to the invention,

FIG. 14 shows a section through the magnetic bearing according to the invention along line XIV-XIV of FIG. 13,

FIG. 15 shows an embodiment of the magnetic bearing according to the invention,

FIG. 16 shows a principle diagram of the magnetic bearing with drive according to the invention,

FIG. 17 shows the current progress of the arrangement shown in FIG. 16, with positive current impulses,

FIG. 18 shows the current progress of the arrangement shown in FIG. 16, with alternating current impulses,

FIG. 19 shows a schematic diagram of the arrangement of bearing coils and drive coils at the magnetic bearing with drive according to the invention,

FIG. 20 shows an embodiment of the magnetic bearing according to the invention with an optical sensor.

### MODE(S) FOR CARRYING OUT THE INVENTION

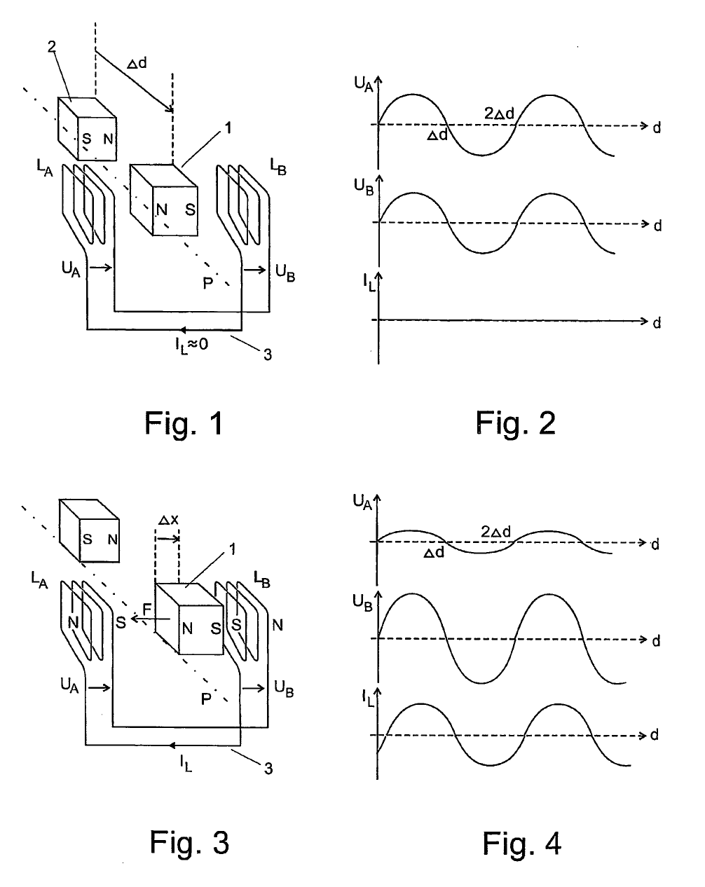

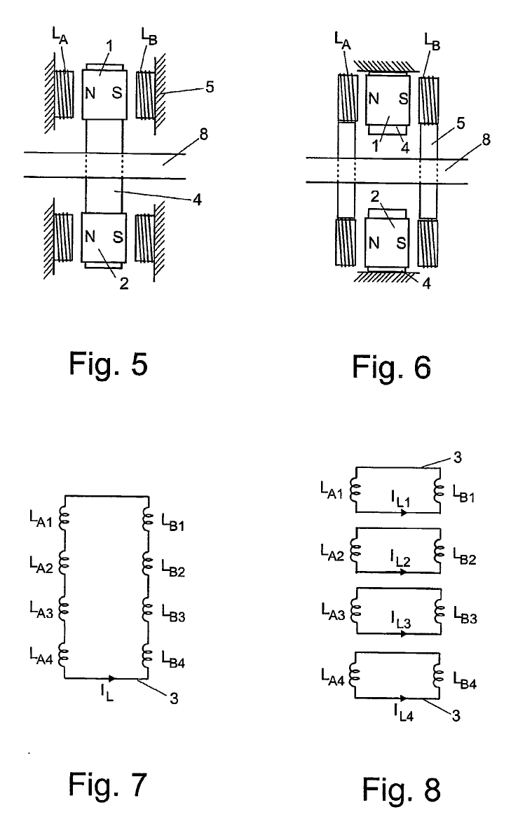

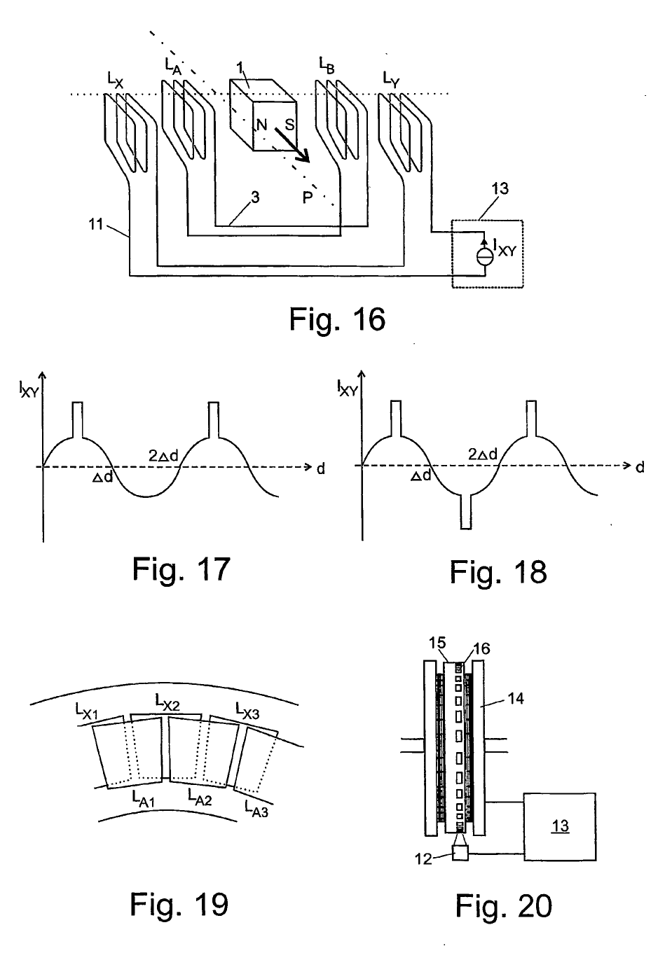

The principle of the invention is explained referring to FIG. 1 to 4. Different axial bearings based on the principle are described referring to FIG. 5 to 15. The passive magnetic bearing according to the invention can be extended by a drive, which is illustrated referring to FIG. 16 to 20.

The coils occurring in the different embodiments can be categorized according to their function, for example in “bearing coils” and “drive coils”. In cases, where no such specification is necessary, in particular at the embodiments without drive, for reasons of simplicity the term “coil” is used without an attribute like “bearing” or “drive”.

The term “polarization axis” used in this document is to be understood as follows: At permanent magnets the polarization axis is the straight line through south and north pole. At coils the polarization axis is the straight line through south and north pole as well, independent of the fact that these do not result until there is a current flow. The polarization axis is invariant regarding a swap of south and north pole.

FIG. 1 shows a principle diagram of the passive magnetic bearing according to the invention. Two coils L_{A}, L_{B} and two permanent magnets 1, 2 are shown. Coil holders and magnet holder are not shown. The permanent magnets 1, 2 move relative to the coils L_{A}, L_{B} on a path P. With this kind of description the case that the permanent magnets 1, 2 are static and the coils L_{A}, L_{B} move instead is not to be excluded. The path P is defined relatively to the coils L_{A}, L_{B} and can thereby also, as in the case above, have a moving frame of reference. The center points of the permanent magnets 1, 2 have a distance of Δd from each other. Along the same path P, Δd is preferably constant, i.e. the permanent magnets 1, 2 are distributed at equal distances. At a particular point in time to each permanent magnet 1, 2 on the path P two coils L_{A}, L_{B} can be assigned. The polarization axes of these two coils L_{A}, L_{B} are on the same straight line. The permanent magnets 1, 2 have each a north pole N and a south pole S. Their polarization axis is straight, i.e. not bent, which is the case, for example, at horse shoe magnets. The consecutive permanent magnets 1, 2 are in each case polarized substantially parallel, but regarding their sign opposed to each other. The polarization axis of magnet 1 is perpendicular to the plane of path P and parallel to the polarization axis of the coils L_{A}, L_{B}. Thereby the magnetic field on the sides of the moving permanent magnets 1, 2 oscillates depending on the speed of the permanent magnets 1, 2. By the movement of the permanent magnets 1, 2, the flux through the coils L_{A} and L_{B} arranged on the sides of path P changes. Thereby a voltage U_{A} or U_{B} results in each of the coils L_{A} and L_{B}. The path P on which the permanent magnets 1, 2 move in the equilibrium position of the bearing is exactly in the middle between the coils L_{A}, L_{B}. Thereby the flux through the two coils L_{A}, L_{B} is equal. The coils L_{A}, L_{B} are series connected in an electric circuit 3, namely in such a way that they have, when there is a current flow, a magnetic polarization opposing each other.

FIG. 2 shows the current and voltage progression of the arrangement of FIG. 1. The values are represented in dependency of the path d passed by the permanent magnets 1, 2. The velocity of the permanent magnets 1, 2 is constant at the shown progression. The voltages U_{A}, U_{B} across the two coils L_{A}, L_{B} oscillate. The current I_{L} through the series connected coils L_{A}, L_{B} is substantially constantly zero, since the voltages U_{A}, U_{B} across the coils L_{A}, L_{B} cancel each other due to the symmetry of the arrangement.

FIG. 3 shows the arrangement of FIG. 1, however, during a deviation of the permanent magnets 1, 2 from the prescribed path P. The deviation is in direction of the polarization axis of the permanent magnets 1, 2. The distance between the center of the permanent magnets 1, 2 and the prescribed path P is Δx. The magnets are thereby not in the central position any more and the arrangement is not symmetric any more, i.e. the coil L_{A} is closer to the permanent magnet 1 than the coil L_{B}. Due to the inhomogeneity of the magnetic field the magnetic flux through the coil L_{A} is now bigger than the one through the coil L_{B}. The voltages U_{A}, U_{B} across the coils do not cancel each other any more. A current I_{L} flows in the electric circuit 3, and thereby also in the coils L_{A}, L_{B}. The coils L_{A}, L_{B} act as electromagnets. A restoring force F acts thereby on the permanent magnet 1. The coil L_{A} acts attracting and the coil L_{B} repelling to the permanent magnet 1. The restoring force F acts against the deviation of the permanent magnets 1, 2 from the prescribed path P.

FIG. 4 shows the current- and voltage progression of the arrangement of FIG. 3. The differences are represented enlarged to illustrate the way of functioning. In contrast to FIG. 2, now the induced voltages U_{A}, U_{B} are not equal any more due to the different distances between coils L_{A}, L_{B} and permanent magnet 1, 2. Thereby a current I_{L} flows. This current again, creates a magnetic field in the coils L_{A}, L_{B}, which causes the restoring force F to act on the permanent magnet 1. This force keeps acting, until the permanent magnets 1, 2 are moving in the central position again, i.e. on the prescribed path P, and the induced voltages U_{A}, U_{B} cancel each other. I_{L} is substantially an alternating current. The restoring force F is therefore pulsating. U_{A}, U_{B} are substantially alternating voltages. The current I_{L} is phase shifted relative to the voltages U_{A}, U_{B}. The phase shift depends on the rotational speed of the bearing and the inductances of the electric circuit. At the shown current progression the phase shift is about 30°. For the stability of the bearing a phase shift of 90° is optimal. The bearing according to the invention is therefore preferably designed such that the phase shift is substantially 90° at the designated maximal rotational speed. This can, as also described referring to FIG. 7, among other, be achieved by connecting an additional inductance in the electric circuit 3 by insertion. The arrangement is asymptotically stable, i.e. the magnets return after a deviation automatically to the equilibrium position.

FIG. 5 shows schematically an embodiment of the bearing according to the invention as axial bearing. However, the bearing according to the invention can also be designed as radial bearing or as linear bearing. The shown axial bearing comprises two static coil holders 5 and one rotating magnet holder 4. Permanent magnets 2 are arranged on the magnet holder 4. The permanent magnets 2 are, regarding their center points, arranged all in the same plane. Such planes, in which several magnets are arranged, are also denoted by the term “magnet plane” in the present document. Analogous planes, in which several coils are arranged, are called “coil plane”. The magnet holder 4 is mounted on a shaft 8. Coils L_{A}, L_{B} are arranged in two planes on coil holders 5 in a ring shape. At the schematic diagram of FIG. 5 two coils are shown of each of these rings. The coils L_{A}, L_{B} consist of an isolated conductor, which is wrapped several times around a holder. The shown arrangement has compared to U.S. Pat. No. 5,302,874 the advantage that the symmetry and thereby the principle of the arrangement is also assured, when the rotor 1, 2, 4 expands due to the centrifugal forces. The coils L are then indeed exposed to a slightly reduced magnetic field, but the induced voltages U_{A}, U_{B} substantially keep canceling each other in the equilibrium position. At U.S. Pat. No. 5,302,874 the expansion of the rotor results in a disruption of the non-flux condition and thereby in energy losses.

FIG. 6 shows schematically an embodiment of the bearing according to the invention as axial bearing with two rotating coil holders 5 and a static magnet holder 4. The magnet holder 4 is designed as ring and can for this reason be seen at two locations in the shown diagram. In this example the coils L_{A} and L_{B} and thereby also the frame of reference of the path P are moving. The permanent magnets 1, 2 are static, but are moving relatively to the path P and its frame of reference.

FIG. 7 shows the circuit diagram of an embodiment of the magnetic bearing according to the invention with two coil holders A, B and series connected coils L_{A1} to L_{A4} and L_{B1} to L_{B4}. In the present document the expression “to connect by insertion” is used also, by which is meant that the electric circuit is cut open at a location and is then closed again by inserting the particular circuit element. The coils L of the bearing according to the invention are real coils. Its resistance R is not shown in this diagram, as well as in the following diagrams. At this, the letter in the index indicates in which coil plane the coil is arranged. The number in the index indicates the number of the coil L in a coil plane counted along the path P. At this, the coils L on the sides of the path P are preferably designed such that they are directly consecutive and thereby cover the entire path P. However, it is also possible to provide distances between the coils or to use smaller coils. All coils are connected to a single electric circuit 3 with current I_{L}. The shown electric circuit 3 is closed directly, i.e. without further components. However, it is also possible to connect a variable resistance by insertion, by which the stiffness of the bearing can be adjusted, or an inductance by which the bearing can be optimized for particular rotation frequencies. In doing so, the inductance is to be dimensioned preferably such that at the designated maximum rotation frequency of the bearing the phase shift between coil voltage and coil current I_{L} is substantially 90°. At this phase shift, the bearing has the greatest stability. Since the magnetic bearing concerned is a passive one, no active elements, such as current or voltage sources are provided. All coils L have preferably the same number of windings, the same inductance and the same resistance. This has the advantage, that the center position of the rotor is also the equilibrium position provided that the coils are arranged symmetrically. The resistance should be small. However, no superconductor is necessary, whereby the apparatus becomes very cost-efficient. A typical value for the average absolute value of the voltage (U_{A1}) across a coil (L_{A1}) during the operation of the bearing is about 1.5V. At an arrangement with twenty coils per coil holder (5) the voltages across the coils (L) of one coil holder (5) sum up to an average absolute value of about 30V all together.

FIG. 8 shows the circuit diagram of an embodiment of the magnetic bearing according to the invention with eight pair-wise switched coils L_{A1} to L_{A4} and L_{B1} to L_{B4}. There are four electric circuits 3 independent from each other with currents I_{L1} to I_{L4}. The circuits 3 are closed. The shown circuit has compared to the circuit of FIG. 7 the advantage that a bearing, which is switched in such a way, acts not only against an axial displacement, but also against a tilting of the rotor.

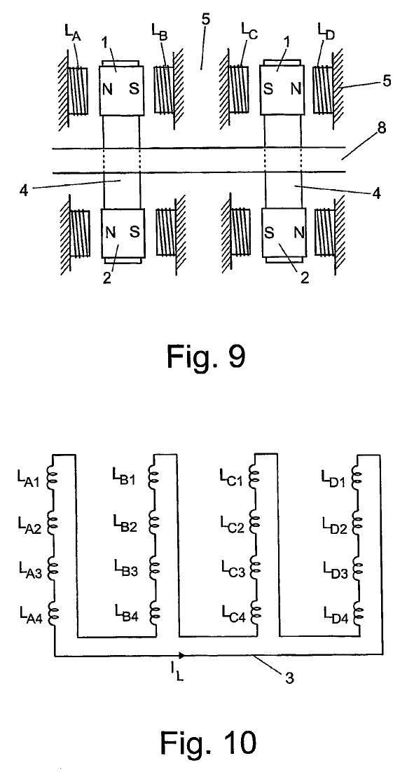

FIG. 9 shows schematically an embodiment of the bearing according to the invention as axial bearing with three static coil holders 5 and two rotating magnet holders 4. The first coil holder 5 holds the coils L_{A}, the second the coils L_{B} and L_{C} and the third the coils L_{D}. In this embodiment there are two circular paths P on which the permanent magnets 1 move. The circles have the same diameter and are coaxial, i.e. a straight line through the center points of the circles is perpendicular to each of the circle planes. Alternatively the invention can also be embodied with concentric circles with different diameters, i.e. with an outer and an inner magnet/coil ring in the same plane. The stability and stiffness of the bearing is improved by additional paths P and additional magnet holders 4 compared to the design with only one path P and only one magnet holder 4.

FIG. 10 shows a preferred circuit diagram for the embodiment of the magnetic bearing according to the invention shown in FIG. 9. The sixteen coils L_{A1} to L_{A4}, L_{B1} to L_{B4}, L_{C1} to L_{C4} and L_{D1} to L_{D4} are series connected. There is only one electric circuit 3 with current I_{L}. The electric circuit 3 is closed.

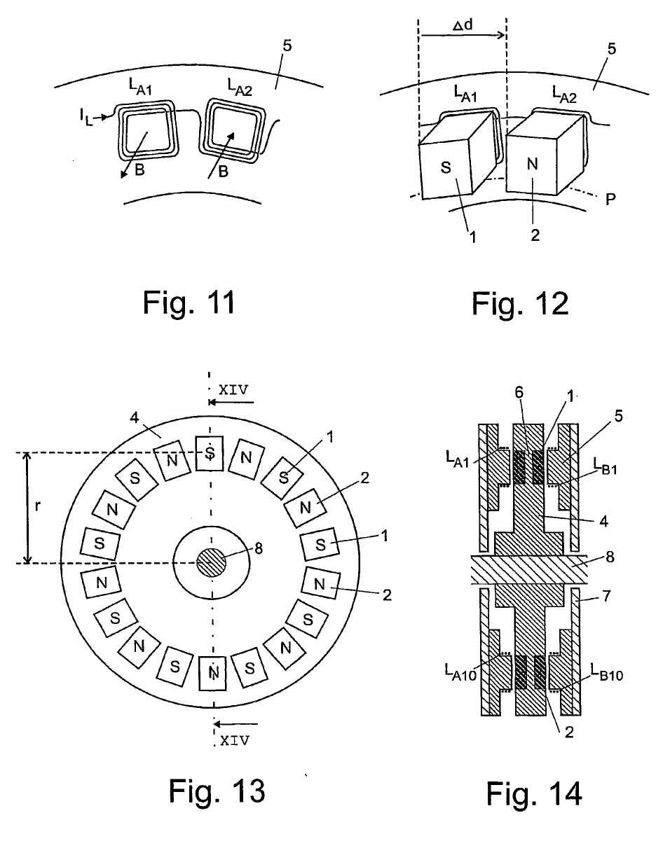

FIG. 11 shows a part of a coil holder 5 of an embodiment of the magnetic bearing according to the invention with the coils L_{A} of the same coil holder being connected to each other, as for example shown in the circuit diagram of FIG. 7 or FIG. 10. Consecutive coils, as for example L_{A1} and L_{A2}, are connected in such a way that they create parallel, but regarding there sign opposing, magnetic fields B when there is a current I_{L}. All together eighteen coils are provided on the coil holder 5 (only two are shown). The coils (L) are distributed on a circle at equal distances. Thereby an arc of 20° results in each case for the distance between the center points of two coils.

FIG. 12 shows the coil holder of FIG. 11, however with the permanent magnets 1, 2 passing it on the path P. The center points of the permanent magnets 1, 2 have a distance Δd from each other. The center points of the coils L_{A1}, L_{A2} also have a distance Δd from each other. At the shown state the flux through the coils L_{A}, L_{B} is maximal. If the permanent magnets are moved forward by their half distance, i.e. by the length Δd/2, the flux through the coils L_{A1}, L_{A2} is zero. After a movement by the length Δd, the flux is maximal again, but it has a different sign.

FIG. 13 shows the magnet holder 4 of an embodiment of the magnetic bearing according to the invention in a side view. The magnet holder has eighteen permanent magnets 1, 2. All permanent magnets 1, 2 have the same distance from the shaft 8 of the rotor 1, 2, 4, 8. The distance between the center point of the magnet and the rotation axis is r in each case. The permanent magnets 1, 2 are arranged facing the viewer alternating with the south pole S or the north pole N. The number of permanent magnets 1, 2 must therefore be even. In the preferred embodiment the number of permanent magnets 1, 2 corresponds to the number of pairs of coils L. Thereby the fields created by the permanent magnets 1, 2 are used optimally and there are only little stray losses.

FIG. 14 shows a section through the magnetic bearing of FIG. 13 along the line XIV-XIV. In contrast to FIG. 13, however, the entire bearing is shown and not only the magnet holder 4. The magnet holder 4 is designed as rotor and is connected to a shaft 8. The coil holders 5 are designed as stator. The coil holders 5 are further connected to a soft iron ring 7, which in particular reduces induced hysteretic losses, for example in the casing, and intensifies the field in the inside of the bearing. By this, the useful flux is increased and the stray flux is restricted. The permanent magnets 1, 2 are divided in two parts and separated by a non magnetic wall 6. Such an arrangement simplifies the mounting of the permanent magnets 1, 2, since in that way they are held by their mutual attraction on the magnet holder 4. The magnet holder 4 comprises recesses which have the shape of the permanent magnets. Thereby the magnets cannot shift sideways. Because the two magnet parts attract each other and thereby press each other against the magnet holder 4, no further fastening means are necessary.

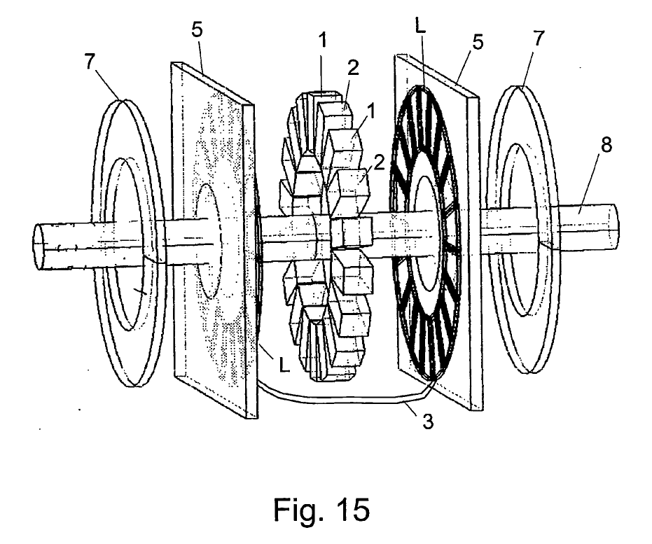

FIG. 15 shows an embodiment of the magnetic bearing according to the invention. The arrangement is axially stretched for a better insight. Eighteen permanent magnets 1, 2 are arranged on a magnet holder which is not shown. During a rotation of the rotor 1, 2, 8 the permanent magnets pass eighteen pairs of coils L. These are arranged on two static coil holders 5 on both sides of the magnets 1, 2. To reduce stray losses of the coils L, two soft iron rings 7 are provided. The permanent magnets have the shape of a cuboid. However, other shapes are possible, for example the shape of a prism.

FIG. 16 shows a principle diagram of the magnetic bearing with drive according to the invention. Two bearing coils L_{A}, L_{B}, two drive coils L_{X}, L_{Y} and one magnet 1 are shown. The principle diagram corresponds substantially to the one of FIG. 1, however, now additional drive elements are provided. The magnetic bearing with drive according to the invention is substantially a passive magnetic bearing according to the invention, in which a drive was integrated. At this, the magnets 1 are used for both, the bearing as well as the drive. The magnets 1 move on a path P. Bearing coils L_{A}, L_{B} are arranged on both sides of path P, by which bearing coils L_{A}, L_{B} restoring forces are exerted on the magnets 1 in case of a deviation from the prescribed path. Drive coils L_{X}, L_{Y} are also arranged on both sides of path P. By means of these drive forces or breaking forces can be exerted onto magnets 1. Preferably the bearing coils L_{A}, L_{B} are arranged directly at the path P and the drive coils L_{X}, L_{Y} are, when viewed from path P, arranged directly behind the bearing coils L_{A}, L_{B}. However, it is also possible to arrange the coils differently, for example the drive coils L_{X}, L_{Y} in front of the bearing coils L_{A}, L_{B} or divided in two, in front and behind the bearing coils L_{A}, L_{B}. The bearing coils, as well as the drive coils have to be arranged in the range of the magnetic fields of the magnets 1, 2. The drive coils L_{X}, L_{Y} are, as will be described in more detail further down below referring to FIG. 19, arranged relatively to the bearing coils L_{A}, L_{B} shifted in direction of the path by half a coil width. The bearing coils L_{A}, L_{B} as well as the drive coils L_{X}, L_{Y} are in each case series connected in an electric circuit 3 or 11. The bearing coils L_{A}, L_{B} are connected such that they have, when there is a current flow, a magnetic polarization opposing each other. Drive coils L_{X}, L_{Y}, however, are switched such, that they have, when there is a current flow, an equally oriented magnetic polarization. Without changing the way of functioning of the arrangement, one of the two drive coils L_{X}, L_{Y} can also be omitted. However, preferably the drive coils L_{X}, L_{Y} are arranged in pairs, wherein the polarization axes of the two coils of a pair are on the same straight line. In the electric circuit 11 of the drive coils L_{X}, L_{Y} a current pulse generator 13 is connected by insertion for the energy supply. Based on the principle described above the bearing with drive according to the invention can be designed as radial, axial or linear bearing.

FIG. 17 shows the current progression of the arrangement shown in FIG. 16. With a current pulse generator periodically positive current impulses are created for supplying the drive coils and driving the bearing rotor. The current pulses are in particular superposed to a current, which results from the voltages induced in the drive coils by the bearing rotation and the non-ideality of the power source, namely each time after the rising edge of the sine of this current.

FIG. 18 shows the current progression of the arrangement shown in FIG. 16. The progression corresponds substantially to the one of FIG. 17, except that not only positive, but alternating positive and negative current pulses are generated, which among other things allows a greater drive power. In particular, starting from the shown signal, current pulses can be omitted. In such a way, the power input can be controlled. For a reduction of the power input only, for example, each second or each tenth power pulse of the signal shown in FIG. 18 is generated.

FIG. 19 is a schematic, partial diagram of the arrangement of the bearing coils and drive coils in a preferred embodiment of the magnet bearing with drive according to the invention. In this exemplary embodiment on each of the two sides of the magnets sixteen bearing coils and sixteen drive coils arranged in a ring are provided. In a further exemplary embodiment, instead of sixteen twenty four coils are provided in each case. The part shown in the figure comprises about three bearing coils L_{A1}, L_{A2}, L_{A3} and three drive coils L_{X1}, L_{X2}, L_{X3}. Consecutive, neighboring drive coils L_{X1}, L_{X2} are connected such that they have, when there is a current flow, a substantially parallel, but regarding the sign opposing polarization. The drive coils L_{X1} to L_{X16} and L_{Y1} to L_{Y16} can, similar as shown referring to FIGS. 7 and 8 for the bearing coils, be connected together in preferably one, but also several, electric circuits, wherein then in particular for each electric circuit a separate power source is provided. The drive coils are preferably series connected, but can also be connected in parallel. Principally each drive coil can also be connected individually to its own power source, wherein then, as the case may be, the requirement of an from coil to coil alternating polarization at neighboring coils and a synchronous polarization for coils opposing each other must be fulfilled by a suitable control of the power sources. The drive coils L_{X1}, L_{X2}, L_{X3} are arranged shifted relatively to the bearing coils L_{A1}, L_{A2}, L_{A3} by half a coil width. This corresponds, regarding the coil currents, coil voltages and fields of the magnets, to a phase shift of 90 degree. This shifted arrangement has the advantage that the flux created by two neighboring and thereby differently polarized drive coils L_{X1}, L_{X2} through a bearing coil L_{A1} superposes and substantially cancels itself. Thereby interactions between the bearing function and the drive function can be reduced, which, among other things, simplifies the simulation and thereby the optimization and control of the magnetic bearing with drive according to the invention.

FIG. 20 shows an embodiment of the magnetic bearing with drive according to the invention as axial bearing. The magnets are arranged on a rotor 15. The polarization axes of the drive coils are oriented axially. The drive coils are arranged in two drive coil planes on both sides of the rotor. In a simplified embodiment one of the two drive coil planes is omitted. The drive coils are, similar as the bearing coils, distributed at equal distances on circles, which are coaxial with the bearing axis. As already mentioned above, the drive coils of the bearing are supplied with current pulses. These current pulses can be generated in a fixed cycle and/or depending on the position and/or movement of the bearing rotor 15. The position and/or movement of the bearing rotor 15 can for example be determined based on the voltages induced in the drive coils or with a hall sensor. In a preferred embodiment of the invention the position and/or movement of the bearing rotor 15 is determined with an optical sensor 12. This sensor 12 is designed to detect markings 16 on the rotor 15 of the bearing. The output signal of the optical sensor 12 is used to control the current pulse generator 13. The markings are preferably designed such, for example as bright and dark sections alternating at a suitable distance, that the output signal of the optical sensor 12 can, regarding its progression through time, be used directly, i.e. solely by a suitable amplification and/or discretization, for controlling a current source in the current pulse generator 13.

In the embodiments of the invention described in the figures permanent magnets are used as magnets. This has the advantage that the bearing does not require a continues energy supply. However, the permanent magnets can, for example, also be replaced by electromagnets, which would allow, among other things, a control of the stiffness of the bearing.

The bearing according to the invention is asymptotically stable. Therefore it does not only rotate in an equilibrium position, but also returns, when there is a deviation, by itself to the same equilibrium position again.

The bearing according to the invention is dynamically stable, i.e. the stability is only assured above a certain rotational speed. Temporary mechanical bearings are provided for the transition phase between the standstill state and the minimum rotational speed necessary for stability. In the preferred embodiment, the bearing according to the invention is optimized for speeds of above 25'000 rotations per minute.

The axial bearings described referring to the figures are radially unstable. However, the instability is so low that the axial bearings can be used in combination with radial bearings for fully contactless bearing of flywheels in energy storage devices. Such energy storage devices are for example suited for electric vehicles. The lifetime of such fully contactless flywheels is almost unlimited.

A preferred embodiment of such an energy storage device with contactless borne flywheel comprises a passive dynamically stabilizing axial magnetic bearing according to the invention and at least one, preferably two, passive radial magnetic bearings. The passive radial magnetic bearings are substantially only based on permanent magnets, i.e. not on coils, and are therefore in contrast to the axial bearing not only dynamically, but also in case of a stopped rotor stabilizing.

While there are shown and described presently preferred embodiments of the invention, it is to be distinctly understood that the invention is not limited thereto but may be otherwise variously embodied and practiced within the scope of the following claims.

1-30. (canceled)

31. Passive magnetic bearing, comprising magnets and bearing coils, wherein the magnets are moveable relatively to the bearing coils along at least one path, wherein the bearing coils are exposed to an oscillating magnetic flux due to the magnetic fields created by the magnets and are connected to each other in one or several electric circuits, wherein for each circuit applies that, when the magnets are moved along the path, the voltages induced by the oscillating magnetic flux in the bearing coils substantially cancel each other at any time and thereby no current flows and, when there is a deviation of the magnets from the path in direction of the polarization axis of the magnets, the voltages induced in the bearing coils do not cancel each other due to the changed distances from the magnets and the thereby changed strength of the magnetic flux such that a current flows and the bearing coils, which the current flows through, exert a restoring force on the magnets.

32. Passive magnetic bearing of claim 31, wherein the bearing coils are arranged on a first side of the path and on a second side of the path, which second side is opposite to the first side, and in each circuit at least one bearing coil of the first side of the path and at least one bearing coil of the second side of the path are connected by insertion.

33. Passive magnetic bearing of claim 31, wherein it is a radial bearing and comprises at least one circular path and the magnets as well as the bearing coils are oriented radially regarding their polarization axes.

34. Passive magnetic bearing of claim 31, wherein it is an axial bearing and comprises at least one circular path and the magnets as well as the bearing coils are oriented axially regarding their polarization axes.

35. Passive magnetic bearing of claim 34, wherein the bearing coils and the magnets have the same distance from the rotation axis.

36. Passive magnetic bearing of claim 34, wherein the magnets are arranged in a magnet plane or symmetrically to a magnet plane and a plurality of bearing coils are arranged on both sides of the magnet plane in two bearing coil planes, wherein the bearing coil planes are arranged symmetrically to the magnet plane.

37. Passive magnetic bearing of claim 31, wherein magnets, which are consecutive along the path, have a substantially parallel, however, regarding the sign opposing polarization.

38. Passive magnetic bearing of claim 31, wherein the magnets are distributed at equal distances along each path.

39. Passive magnetic bearing of claim 31, wherein all bearing coils are distributed at equal distances on circles parallel to the plane of the path.

40. Passive magnetic bearing of claim 38, wherein the distance between the center points of two neighboring bearing coils is equal to the distance between the center points of two neighboring magnets.

41. Passive magnetic bearing of claim 31, wherein it comprises pairs each with a first and a second bearing coil, wherein, in each case, the polarization axes of the first and the second bearing coil lie on the same straight line and in particular the first and the second bearing coil are connected to each other in the same electric circuit separate from further bearing coils.

42. Passive magnetic bearing of claim 31, wherein all bearing coils are series connected in a single electric circuit.

43. Passive magnetic bearing of claim 42, wherein the bearing coils are series connected and oriented in such a way that neighboring bearing coils on the same side of the path have, when there is a current flow, a substantially parallel, but regarding the sign opposing magnetic polarization.

44. Passive magnetic bearing of claim 31, comprising twice as many bearing coils as magnets.

45. Passive magnetic bearing of claim 31, wherein to each path the same number of magnets is assigned.

46. Passive magnetic bearing of claim 45, wherein the number of magnets is between ten and thirty.

47. Passive magnetic bearing of claim 31, wherein the magnets are moveable and the bearing coils are static.

48. Passive magnetic bearing of claim 31, wherein the magnets are static and the bearing coils are moveable.

49. Passive magnetic bearing of claim 31, wherein exactly one path is provided.

50. Passive magnetic bearing of claim 49, wherein the magnet bearing comprises two bearing coil holders and a magnet holder arranged in between.

51. Passive magnetic bearing of claim 31, wherein at least two paths are provided, wherein the paths run along coaxial circles.

52. Passive magnetic bearing of claim 51, wherein the paths lie in the same plane.

53. Passive magnetic bearing of claim 51, wherein the paths run along circles with equal diameter.

54. Passive magnetic bearing of claim 51, wherein it comprises at least two magnet holders and at least three bearing coil holders.

55. Passive magnetic bearing of claim 54, wherein each of the magnet holders is arranged between two bearing coil holders.

56. Passive magnetic bearing of claim 31, wherein it comprises means for shielding.

57. Passive magnetic bearing of claim 56, wherein the means for shielding are soft iron rings.

58. Passive magnetic bearing of claim 56, wherein the means for shielding are arranged such that the ends of the bearing coils, which are not directed towards a path, are covered by it.

59. Passive magnetic bearing of claim 31, wherein the magnets, in each case, are designed as two parts, i.e. consisting of two parts, wherein the two parts attract each other.

60. Passive magnetic bearing of claim 59, wherein a magnet holder comprises recesses on two sides opposing each other for receiving the parts of the magnets.

61. Passive magnetic bearing of claim 31, wherein the conductors of all bearing coils are of a material with finite conductivity.

62. Passive magnetic bearing of claim 31, wherein all bearing coils have the same number of windings, the same inductance and the same resistance.

63. Passive magnetic bearing of claim 31, wherein in at least one electric circuit an additional inductance is connected by insertion.

64. Passive magnetic bearing of claim 63, wherein the additional inductance is dimensioned such that in the electric circuit at a designated maximum rotation frequency of the bearing the phase shift between the voltage across a bearing coil and the current is substantially 90°.

65. Magnetic bearing with drive which consists of a passive magnetic bearing of claim 31 and a drive, wherein the magnets serve for both, a bearing as well as a driving of the rotor.

66. Magnetic bearing with drive of claim 65, wherein the bearing comprises drive coils, which are arranged sideways of path in the magnetic fields created by the magnets.

67. Magnetic bearing with drive of claim 66, wherein the drive coils are, when viewed from the path, arranged behind the bearing coils.

68. Magnetic bearing with drive of claim 67, wherein the drive coils are directly adjacent to the bearing coils.

69. Magnetic bearing with drive of claim 66, wherein the drive coils are arranged on a first side of the path and on a second side of the path opposite to the first side.

70. Magnetic bearing with drive of claim 66, wherein the drive coils are arranged as pairs, wherein in each case drive coils arranged as a pair have polarization axes which lie on the same straight line.

71. Magnetic bearing with drive of claim 66, wherein it is an axial bearing, wherein the drive coils have polarization axes, which are substantially oriented axially.

72. Magnetic bearing with drive of claim 66, wherein the drive coils are arranged in one or two drive coil planes.

73. Magnetic bearing with drive of claim 72, wherein the drive coils are distributed at equal distances on one or, as the case may be, two circles, which are coaxial with an axis of the bearing.

74. Magnetic bearing with drive of claim 66, wherein the drive coils are connected to a power source.

75. Magnetic bearing with drive of claim 74, wherein the drive coils are connected to a current pulse generator.

76. Magnetic bearing with drive of claim 74, wherein the power source is controlled depending on a position and/or movement of the rotor.

77. Magnetic bearing with drive of claim 76 wherein for determining said position and/or movement an optical sensor and markings are provided on the rotor.

78. Magnetic bearing with drive of claim 66, wherein the drive coils are connected such and arranged relatively to the bearing coils such that a magnetic flux created by the individual drive coils through the bearing coils superposes and substantially cancels itself.

79. Magnetic bearing with drive of claim 78, wherein the bearing coils and the drive coils are arranged shifted relatively to each other by a phase angel of 90°.

80. Magnetic bearing with drive of claim 66, wherein the drive coils are connected in a common electric circuit such that neighboring drive coils arranged on the same side of the path have, when there is a current flow, a substantially parallel, but regarding the sign opposing magnetic polarization and, as the case may be, drive coils on different sides of the path, the polarization axes of which lie on the same straight line, have an equally oriented magnetic polarization.
